(19) United States
(12) Patent Application Publication
(10) Pub. No.: US 2016/0277381 A1
(43) Pub. Date: Sep. 22, 2016

(54) SECURITY CHECK METHOD AND SYSTEM, TERMINAL, VERIFICATION SERVER

(71) Applicant: Tencent Technology (Shenzhen) Company Limited, Shenzhen (CN)

(72) Inventors: Kun YUAN, Shenzhen (CN); Maofeng LEI, Shenzhen (CN); Xiaolong ZHOU, Shenzhen (CN); Ken CHEN, Shenzhen (CN); Xiaowei JIANG, Shenzhen (CN); Yuanbiao XIAO, Shenzhen (CN); Chenggui MA, Shenzhen (CN)

(21) Appl. No.: 15/169,200

(22) Filed: May 31, 2016

Related U.S. Application Data
(63) Continuation of application No. PCT/CN2015/070500, filed on Jan. 12, 2015.

(30) Foreign Application Priority Data
Jan. 16, 2014 (CN) 201410020448.X

(51) Int. Cl. H04L 29/06; H04L 29/08; G06F 3/0484; G06F 3/0482; H04W 12/06; G06F 9/50

(52) U.S. Cl. CPC H04L 63/08; H04L 63/123; H04W 12/06; G06F 9/5077; G06F 3/04842; G06F 3/0482; H04L 67/02

(57) ABSTRACT

Described are a security check method and system, a terminal, and a verification server. The method includes: receiving a selection operation on one of service provider identifiers; triggering an interface switching instruction according to the selection operation, and switching, according to the interface switching instruction, to an original virtual resource accumulation page corresponding to a user identifier and the service provider identifier selected by a user; receiving a virtual resource acquisition instruction input by the user on the original virtual resource accumulation page; switching from the original virtual resource accumulation page to a verification interface according to the virtual resource acquisition instruction; receiving verification information input on the verification interface, and uploading the verification information and the service provider identifier to a verification server for verification; and receiving a new virtual resource accumulation page that is returned by a virtual resource server after verification of the verification server succeeds.

### RELATED APPLICATIONS

This application is a continuation application of PCT Patent Application No. PCT/CN2015/070500, entitled “SECURITY CHECK METHOD AND SYSTEM, TERMINAL, VERIFICATION SERVER” filed on Jan. 12, 2015, which claims priority to Chinese Patent Application No. 201410020448.X, “SECURITY CHECK METHOD AND SYSTEM, TERMINAL, VERIFICATION SERVER,” filed on Jan. 16, 2014, both of which are hereby incorporated by reference in their entirety.

### FIELD OF THE TECHNOLOGY

The present disclosure relates to the field of Internet technologies, and in particular, to a security check method and system, a terminal, and a verification server.

### BACKGROUND OF THE DISCLOSURE

O2O, that is, Online TO Offline, refers to that offline service information is combined with the Internet, so that the Internet becomes a foreground of an offline service, and by using this foreground, the offline service can attract consumers on line, and a user can view the offline service information and select a service on line. A conventional check method includes: (1) A user shows, to a service provider, a credential acquired by using an online O2O platform, and gets a redeemed resource after the service provider manually completes bonus point accumulation or bonus point deduction in a system. (2) A service provider provides a bonus point accumulation card to a user, and each time the user completes a service at the service provider, the service provider adds a bonus point to the bonus point accumulation card owned by the user.

The conventional check methods need manual verification, resulting in low efficiency and accuracy.

### SUMMARY

Based on this, it is necessary to provide a security check method and system with high efficiency and accuracy, to solve the problem of low efficiency and accuracy of the conventional check methods caused by manual verification.

In addition, a terminal and a verification server are further provided.

A security check method includes:

logging in to an electronic operation platform by using a user identifier, an operation interface provided by the electronic operation platform having multiple service provider identifiers;

receiving a selection operation on one of the service provider identifiers on the operation interface;

triggering an interface switching instruction according to the selection operation, and switching, according to the interface switching instruction, to an original virtual resource accumulation page corresponding to the user identifier and the service provider identifier selected by a user;

receiving a virtual resource acquisition instruction input by the user on the original virtual resource accumulation page;

switching from the original virtual resource accumulation page to a verification interface according to the virtual resource acquisition instruction;

receiving verification information input on the verification interface, and uploading the verification information and the service provider identifier to a verification server for verification; and

receiving a new virtual resource accumulation page that is returned by a virtual resource server after verification of the verification server succeeds, where the new virtual resource accumulation page includes an updated virtual resource accumulation quantity corresponding to the user identifier.

A security check method includes:

receiving an interface switching instruction, and returning, to a terminal according to the interface switching instruction, an original virtual resource accumulation page corresponding to a user identifier and a service provider identifier selected by a user;

receiving a virtual resource acquisition instruction input on the original virtual resource accumulation page, and returning a verification interface according to the virtual resource acquisition instruction;

receiving the service provider identifier and verification information that is input on the verification interface that are uploaded by the terminal, and verifying the service provider identifier and the verification information, to obtain a verification result; and

transmitting the verification result to a virtual resource server, so that the virtual resource server returns a new virtual resource accumulation page to the terminal after verification succeeds, where the new virtual resource accumulation page includes an updated virtual resource accumulation quantity corresponding to the user identifier.

A terminal includes:

a page switching module, configured to: log in to an electronic operation platform by using a user identifier, an operation interface provided by the electronic operation platform having multiple service provider identifiers; receive a selection operation on one of the service provider identifiers on the operation interface; trigger an interface switching instruction according to the selection operation; and switch, according to the interface switching instruction, to an original virtual resource accumulation page corresponding to the user identifier and the service provider identifier selected by a user;

an instruction acquisition module, configured to receive a virtual resource acquisition instruction input by the user on the original virtual resource accumulation page;

an interface switching module, configured to switch from the original virtual resource accumulation page to a verification interface according to the virtual resource acquisition instruction;

an input module, configured to receive verification information input on the verification interface;

an uploading module, configured to upload the verification information and the service provider identifier to a verification server for verification; and

an updated page receiving module, configured to receive a new virtual resource accumulation page that is returned by a virtual resource server after verification of the verification server succeeds, where the new virtual resource accumulation page includes an updated virtual resource accumulation quantity corresponding to the user identifier.

A verification server includes:

an information receiving module, configured to receive an interface switching instruction;

a returning module, configured to return, to a terminal according to the interface switching instruction, an original virtual resource accumulation page corresponding to a user identifier and a service provider identifier selected by a user, where the information receiving module is further configured to receive a virtual resource acquisition instruction input on the original virtual resource accumulation page;

the returning module is further configured to return a verification interface according to the virtual resource acquisition instruction; and

the information receiving module is further configured to receive the service provider identifier and verification information that is input on the verification interface that are uploaded by the terminal;

a verification module, configured to verify the received service provider identifier and verification information, to obtain a verification result; and

a transmission module, configured to transmit the verification result to a virtual resource server, so that the virtual resource server returns a new virtual resource accumulation page to the terminal after verification succeeds, where the new virtual resource accumulation page includes an updated virtual resource accumulation quantity corresponding to the user identifier.

A security check system includes a terminal, a verification server, and a virtual resource server, where the terminal is the foregoing terminal, and the verification server is the foregoing verification server.

In the security check method and system, the terminal, and the verification server, verification information is input on a verification interface to perform virtual resource accumulation, which improves the efficiency and accuracy; and verification is completed by using a user terminal, which does not need to add a new hardware device to a service provider, and therefore reduces the cost.

### BRIEF DESCRIPTION OF THE DRAWINGS

FIG. 1 is a schematic diagram of a security check system according to an implementation manner;

FIG. 2 is a flowchart of a security check method according to an implementation manner;

FIG. 3 is a schematic diagram of a verification interface according to an implementation manner;

FIG. 4 is a schematic diagram of a verification interface according to another implementation manner;

FIG. 5 is a flowchart of a security check method according to another implementation manner;

FIG. 6 is a schematic diagram of an original virtual resource accumulation page according to another implementation manner;

FIG. 7 is a schematic diagram of a new virtual resource accumulation page according to another implementation manner;

FIG. 8 is a schematic diagram of a page for confirming bonus resource redemption according to another implementation manner;

FIG. 9 is a flowchart of a security check method according to another implementation manner;

FIG. 10 is an interaction sequence diagram of a security check method according to another implementation manner;

FIG. 11 is a schematic structural diagram of the system in FIG. 1;

FIG. 12 is a schematic structural diagram of the system in FIG. 1; and

FIG. 13 is a diagram of modules of a terminal implementing a security check method.

### DESCRIPTION OF EMBODIMENTS

In order to make the objectives, technical solutions, and advantages of the present disclosure more comprehensible, the present disclosure is described in further detail below with reference to the accompanying drawings and embodiments. It should be understood that, the specific embodiments described herein are merely used for explaining the present disclosure, instead of limiting the present disclosure.

Unless the context clearly indicates otherwise, singular elements or components in the present disclosure may be in the plural and vice versa, which is not limited in the present disclosure. Although steps in the present disclosure are labeled with numbers, such numbers are not intended to limit the order of these steps. Unless the order of steps is explicitly stated or it is explicitly stated that a step needs to be performed on the basis of another step, the relative order of steps can be adjusted. It may be understood that, the term “and/or” used in the specification involves and includes any or all possible combinations of one or more associated listed items.

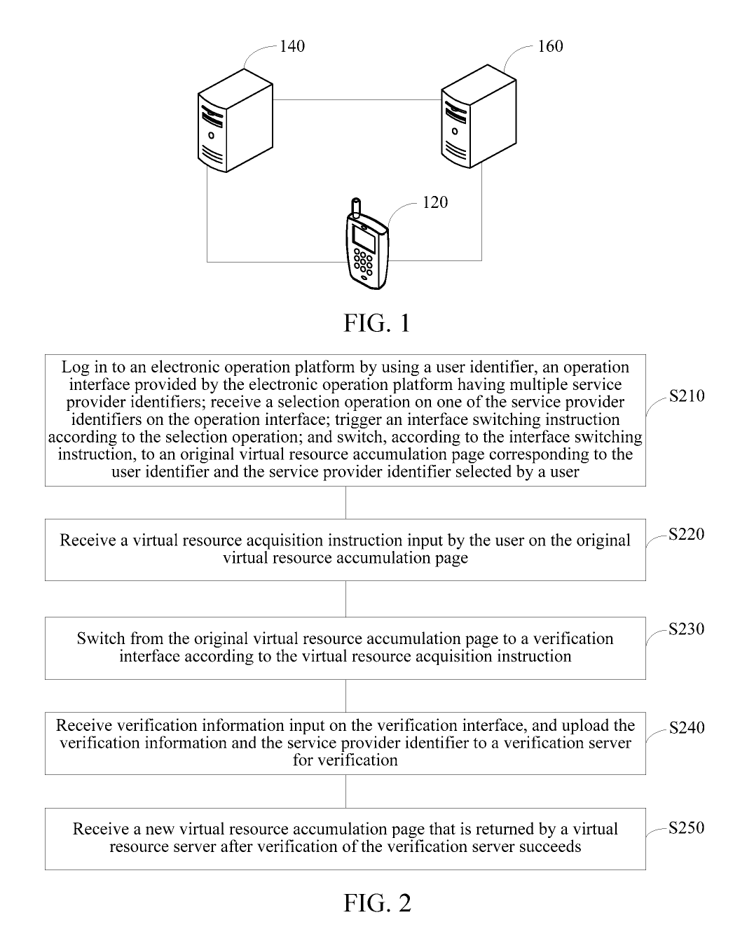

Refer to FIG. 1, which shows a security check system 100 according to an implementation manner. The system 100 includes a terminal 120, a verification server 140, and a virtual resource server 160.

The terminal 120 may be a smart phone, a tablet computer, an e-book reader, a moving picture experts group audio layer III (MP3) player, a moving picture experts group audio layer IV (MP4) player, a portable laptop computer, a desktop computer, or the like.

An application program that can read and identify a user identifier and a service provider identifier selected by a user is installed in the terminal 120. The user identifier is a unique identifier used for distinguishing a user identity, and may be an instant messaging account associated with an O2O platform or an account registered with the O2O platform, for example, the instant messaging account may be a digit string 10000, and the account registered with the O2O platform may be ct0001. The service provider identifier is a unique identifier used for distinguishing a service provider identity, and may be a network address domain name of a service provider or a unique number allocated by the O2O platform.

The verification server 140 stores verification information and a service provider identifier. The verification information may include a verification date and a sequence number, or include a character string, or include a webpage address parameter corresponding to a two-dimensional code, or the like.

The virtual resource server 160 stores a virtual resource accumulation quantity corresponding to the user identifier and service provider identifier and a preset virtual resource accumulation quantity that can be redeemed into a bonus resource. A virtual resource may be represented by, but not limited to, a stamp, a star, a diamond, a red heart, a bonus point, or the like.

Refer to FIG. 2, which is a flowchart of a security check method according to an implementation manner. This embodiment is exemplarily described from the perspective of the terminal in the system shown in FIG. 1 to which the security check method is applied. The security check method includes:

S210: Log in to an electronic operation platform by using a user identifier, an operation interface provided by the electronic operation platform having multiple service provider identifiers; receive a selection operation on one of the service provider identifiers on the operation interface; trigger an interface switching instruction according to the selection operation; and switch, according to the interface switching instruction, to an original virtual resource accumulation page corresponding to the user identifier and the service provider identifier selected by a user.

The platform is an O2O platform. The user may use an instant messaging account associated with the platform as a unique user identifier for logging in to all service provider pages; and the user may also use an account registered with the platform as a unique user identifier for logging in to all service provider pages.

The original virtual resource accumulation page includes an original virtual resource accumulation quantity corresponding to the user identifier.

The original virtual resource accumulation page further includes a virtual resource acquisition control.

S220: Receive a virtual resource acquisition instruction input by the user on the original virtual resource accumulation page.

S230: Switch from the original virtual resource accumulation page to a verification interface according to the virtual resource acquisition instruction.

S240: Receive verification information input on the verification interface, and upload the verification information and the service provider identifier to a verification server for verification.

S250: Receive a new virtual resource accumulation page that is returned by a virtual resource server after verification of the verification server succeeds.

The new virtual resource accumulation page includes an updated virtual resource accumulation quantity corresponding to the user identifier.

In the security check method, verification information is input on a verification interface, the verification information and a service provider identifier are uploaded to a verification server for verification, and virtual resource accumulation is performed after verification succeeds, which improves the efficiency and accuracy.

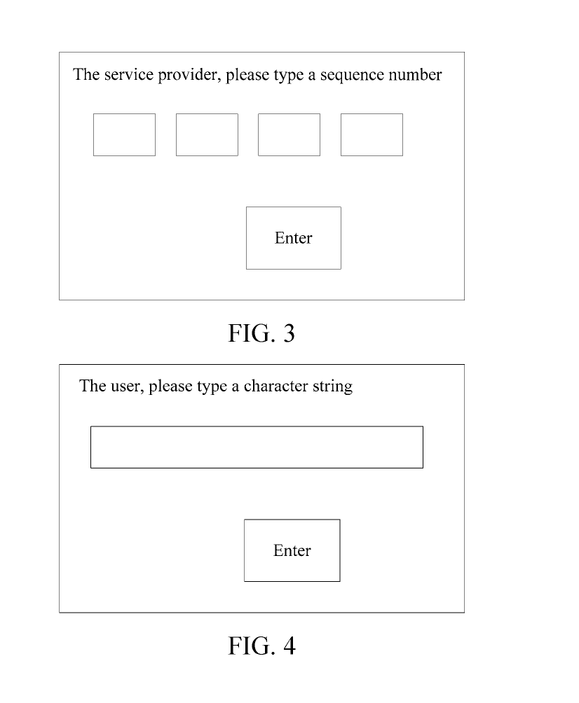

Referring to FIG. 3, further, in this implementation manner, the step S240 of receiving verification information input on the verification interface, and uploading the verification information and the service provider identifier to a verification server for verification includes: receiving verification information input by a service provider on the verification interface, and uploading the verification information and the service provider identifier to the verification server, so that verification server compares the uploaded verification information and service provider identifier with verification information and a service provider identifier that are pre-stored, and verification succeeds if the uploaded verification information and service provider identifier are the same as the pre-stored verification information and service provider identifier.

Table 1 records a correspondence of verification information input by the service provider. With reference to Table 1, the uploaded verification information, that is, the verification information input by the service provider includes a verification date and a sequence number input by the service provider and corresponding to the verification date. Table 2 records a correspondence between verification information stored by the verification server and a service provider identifier. With reference to Table 2, the pre-stored verification information includes a pre-stored sequence number and verification date, and the verification date and the sequence number correspond to a service provider identifier.

TABLE 1

| Verification date | Sequence number |
|---|---|
| 20131031 | 123456 |
| 20131101 | 234567 |
| 20131102 | 345678 |

TABLE 2

| Verification date | Service provider identifier | Sequence number |
|---|---|---|
| 20131031 | 123 | 123456 |
| 20131031 | 234 | 876543 |
| 20131101 | 123 | 234567 |

For the purpose of security, sequence numbers may be updated once every day, that is, be valid for one day and invalid in the next day. After receiving the service provider identifier and the verification information that is input by the service provider that are provided by the terminal, the verification server first determines, according to the service provider identifier, which service provider a verification request is from, then queries for a corresponding verification date and sequence number according to the service provider identifier, and determines whether verification succeeds by comparing the uploaded sequence number with a preset sequence number to determine whether the two match. If the user tries to find the sequence number by means of brute force cracking, the verification server determines that verification for a same user identifier fails continuously in a period of time, and therefore prohibits verification for the user identifier performed in preset further time (such as 1 hour or 2 hours). If a sequence number is leaked, the verification server also feeds back everyday abnormal virtual resource accumulation to the service provider as soon as possible.

Referring to FIG. 4, in another implementation manner, the step of receiving verification information input on the verification interface, and uploading the verification information and the service provider identifier to a verification server for verification may also include: receiving verification information input by the user on the verification interface, and uploading the verification information and the service provider identifier to the verification server, so that verification server compares the uploaded verification information and service provider identifier with verification information and a service provider identifier that are pre-stored, and verification succeeds if the uploaded verification information and service provider identifier are the same as the pre-stored verification information and service provider identifier.

The uploaded verification information, that is, the verification information input by the user, includes a character string input by the user. The pre-stored verification information includes a pre-stored character string.

For the purpose of security, the character string is one-off. The user may log in to the platform at any time, to compete verification by inputting a character string on the verification interface, to perform virtual resource accumulation. The character string may be a paper card that is pre-allocated to the service provider by using the platform, and then delivered by the service provider to the user in an offline transaction. After verification is completed, the character string is invalid immediately. A paper card quantity may be determined according to a validity period×a daily sales quantity.

In another implementation manner, the step of receiving verification information input on the verification interface, and uploading the verification information and the service provider identifier to a verification server for verification may also include: receiving a webpage address and webpage address parameter obtained by scanning a two-dimensional code on the verification interface, receiving a virtual resource acquisition trigger instruction on a page corresponding to the webpage address, and uploading the verification information and the service provider identifier to the verification server according to the trigger instruction, so that the verification server compares the uploaded verification information and service provider identifier with verification information and a service provider identifier that are pre-stored, and verification succeeds if the uploaded verification information and service provider identifier are the same as the pre-stored verification information and service provider identifier.

The uploaded verification information includes the webpage address parameter obtained by scanning the two-dimensional code. The pre-stored verification information includes a pre-stored webpage address parameter.

For the purpose of security, each two-dimensional code is different, and a webpage address corresponding to a different two-dimensional code has a different webpage address parameter. After opening the webpage address by scanning the two-dimensional code, the user clicks a virtual resource acquisition button on the page to initiate verification, which actually is submitting this unique webpage address parameter to the verification server. The webpage address parameter is compared with the pre-stored webpage address parameter, and verification succeeds if the webpage address parameter is the same as the pre-stored webpage address parameter. In addition, the verification server may further determine, by determining whether the webpage address parameter was verified before, whether current verification is effective.

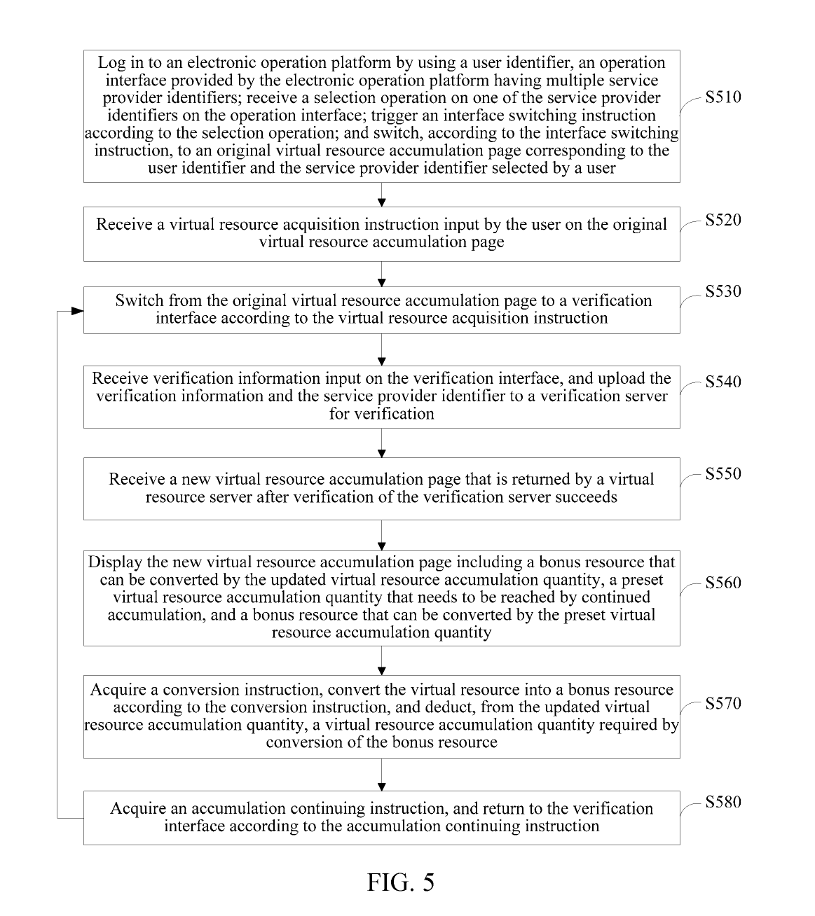

Refer to FIG. 5, which is a flowchart of a security check method according to another implementation manner. In this embodiment, the new virtual resource accumulation page may further include a bonus resource that can be redeemed by the updated virtual resource accumulation quantity, a preset virtual resource accumulation quantity that needs to be reached by continued accumulation, and a bonus resource that can be redeemed by the preset virtual resource accumulation quantity. The security check method of this embodiment includes:

S510: Log in to an electronic operation platform by using a user identifier, an operation interface provided by the electronic operation platform having multiple service provider identifiers; receive a selection operation on one of the service provider identifiers on the operation interface; trigger an interface switching instruction according to the selection operation; and switch, according to the interface switching instruction, to an original virtual resource accumulation page corresponding to the user identifier and the service provider identifier selected by a user.

The platform is an O2O platform. The user may use an instant messaging account associated with the platform as a unique user identifier for logging in to all service provider pages; and the user may also use an account registered with the platform as a unique user identifier for logging in to all service provider pages.

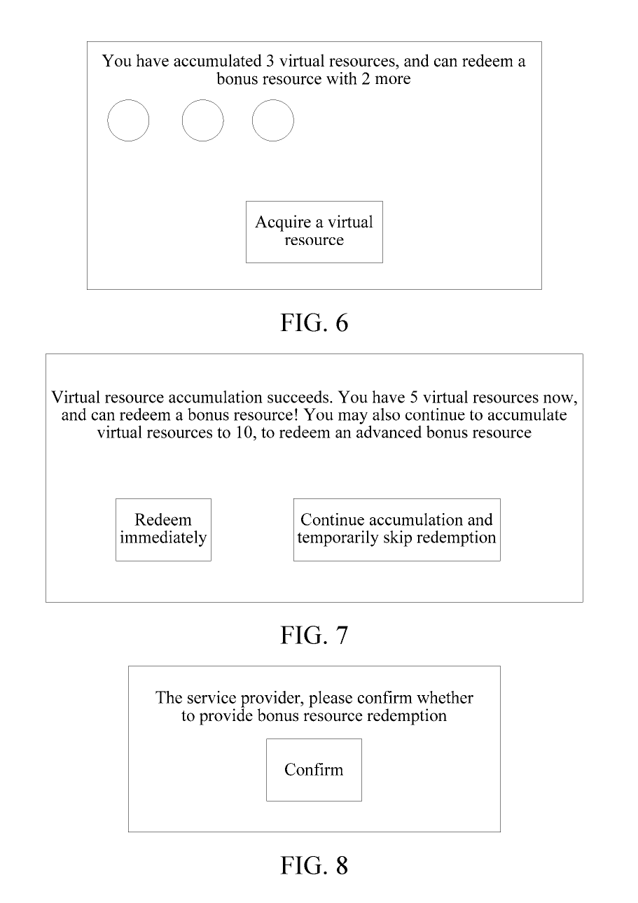

With reference to FIG. 6, the original virtual resource accumulation page includes an original virtual resource accumulation quantity, a preset virtual resource accumulation quantity that needs to be reached by continued accumulation, and a bonus resource that can be redeemed by the preset virtual resource accumulation quantity, which correspond to the user identifier. A virtual resource may be represented by, but not limited to, a stamp, a star, a diamond, a red heart, a bonus point, or the like. The bonus resource may include a physical resource (such as a drink, a doll, a knapsack, a free dish, or the like), a virtual resource (such as a virtual currency, a member of an instant messaging software application, a game coin, or the like) or a consumption discount (for example, the user can enjoy a 20% consumption discount with 5 virtual resources).

The original virtual resource accumulation page further includes a virtual resource acquisition control.

S520: Receive a virtual resource acquisition instruction input by the user on the original virtual resource accumulation page.

S530: Switch from the original virtual resource accumulation page to a verification interface according to the virtual resource acquisition instruction.

S540: Receive verification information input on the verification interface, and upload the verification information and the service provider identifier to a verification server for verification.

S550: Receive a new virtual resource accumulation page that is returned by a virtual resource server after verification of the verification server succeeds.

The new virtual resource accumulation page includes an updated virtual resource accumulation quantity corresponding to the user identifier.

S560: Display the new virtual resource accumulation page including the bonus resource that can be redeemed by the updated virtual resource accumulation quantity, the preset virtual resource accumulation quantity that needs to be reached by continued accumulation, and the bonus resource that can be redeemed by the preset virtual resource accumulation quantity.

With reference to FIG. 7, the new virtual resource accumulation page includes the bonus resource that can be redeemed by the updated virtual resource accumulation quantity, the preset virtual resource accumulation quantity that needs to be reached by continued accumulation, and the bonus resource that can be redeemed by the preset virtual resource accumulation quantity.

The new virtual resource accumulation page includes a control for immediate redemption and a control for continuing accumulation and temporarily skipping redemption.

S570: Acquire a redeem instruction, redeem the virtual resource for a bonus resource according to the redeem instruction, and deduct, from the updated virtual resource accumulation quantity, a virtual resource accumulation quantity required by redeeming the bonus resource.

With reference to FIG. 8, after the user clicks the control of immediate redemption, the terminal displays a confirmation page, and after confirmation of the service provider, the virtual resource accumulation quantity required by redeeming the bonus resource is deducted from the updated virtual resource accumulation quantity, and the service provider delivers the bonus resource.

S580: Acquire an accumulation continuing instruction, and return to the verification interface according to the accumulation continuing instruction.

It should be noted that, if security check is performed only to obtain a virtual resource and perform update and accumulation without bonus resource redemption by using a virtual resource, steps S560 to S580 can be omitted.

To conclude, in the security check method of this embodiment, a terminal logs in to an electronic operation platform by using a user identifier, an operation interface provided by the electronic operation platform having multiple service provider identifiers, receives a selection operation on one of the service provider identifiers on the operation interface, triggers an interface switching instruction according to the selection operation, and uploads, to a virtual resource server according to the interface switching instruction, the user identifier and the service provider identifier selected by a user; then the terminal displays an original virtual resource accumulation page returned by the virtual resource server, where the virtual resource accumulation page includes a virtual resource accumulation quantity corresponding to the user identifier and the service provider identifier; next, the terminal receives a virtual resource acquisition instruction input by the user on the virtual resource accumulation page, and switches from the original virtual resource accumulation page to a verification interface according to the virtual resource acquisition instruction; next, the terminal receives verification information input on the verification interface, and uploads the verification information and the service provider identifier to a verification server for verification; and finally, after verification of the verification server succeeds, the terminal receives a new virtual resource accumulation page returned by the virtual resource server, where the new virtual resource accumulation page includes an updated virtual resource accumulation quantity corresponding to the user identifier.

In the security check method of this embodiment, the verification information is input on the verification interface, the verification information and the service provider identifier are uploaded to the verification server for verification, and virtual resource accumulation is performed after verification succeeds, which improves the efficiency and accuracy. In addition, a preset virtual resource accumulation quantity is redeemed into a bonus resource, which effectively establishes a positive relationship between the service provider and the user, improves the user loyalty, and enhances the connection between the service provider and the user.

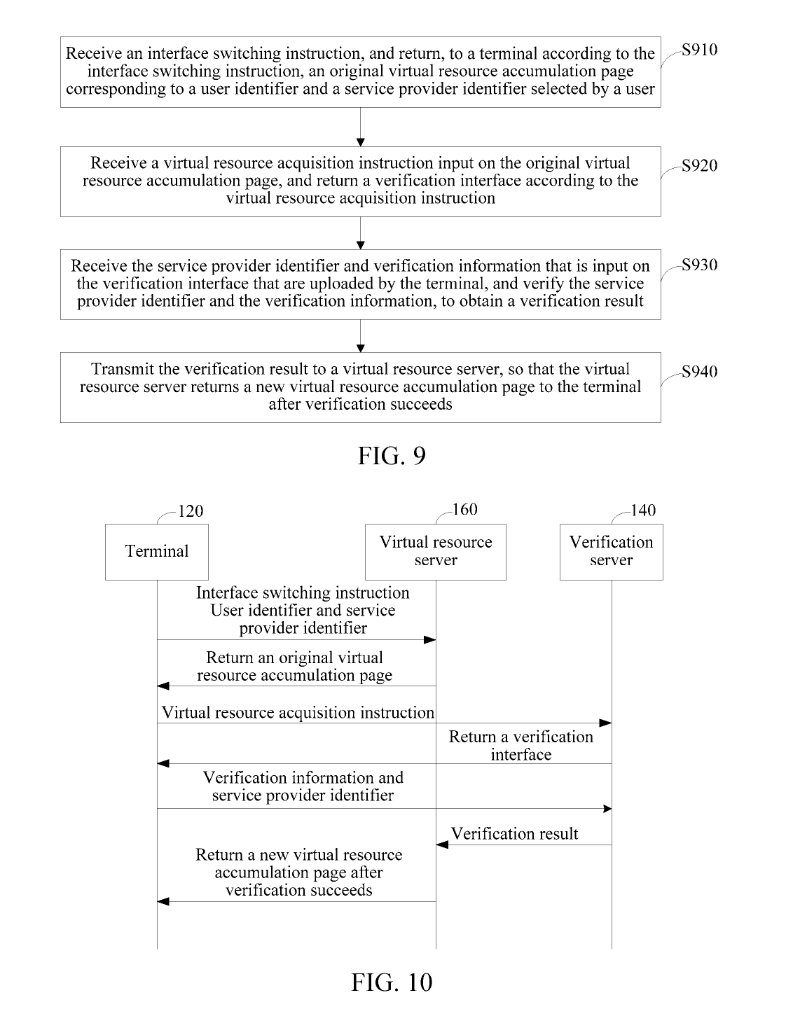

Refer to FIG. 9, which is a flowchart of a security check method according to an implementation manner. This embodiment is exemplarily described from the perspective of the verification server in the system shown in FIG. 1 to which the security check method is applied. The security check method includes:

S910: Receive an interface switching instruction, and return, to a terminal according to the interface switching instruction, an original virtual resource accumulation page corresponding to a user identifier and a service provider identifier selected by a user.

S920: Receive a virtual resource acquisition instruction input on the original virtual resource accumulation page, and return a verification interface according to the virtual resource acquisition instruction.

S930: Receive the service provider identifier and verification information that is input on the verification interface that are uploaded by the terminal, and verify the service provider identifier and the verification information, to obtain a verification result.

S940: Transmit the verification result to a virtual resource server, so that the virtual resource server returns a new virtual resource accumulation page to the terminal after verification succeeds.

Further, in this implementation manner, the step S930 of receiving the service provider identifier and verification information that is input on the verification interface that are uploaded by the terminal, and verifying the service provider identifier and the verification information, to obtain a verification result includes: receiving the service provider identifier and the verification information that are uploaded by the terminal, and comparing the uploaded verification information and service provider identifier with verification information and a service provider identifier that are pre-stored, where verification succeeds if the uploaded verification information and service provider identifier are the same as the pre-stored verification information and service provider identifier.

The uploaded verification information includes a verification date and a sequence number input by a service provider on the verification interface and corresponding to the verification date. The pre-stored verification information includes a pre-stored sequence number and verification date.

It may be understood that, in another implementation manner, the step of receiving the service provider identifier and verification information that is input on the verification interface that are uploaded by the terminal, and verifying the service provider identifier and the verification information, to obtain a verification result may also include: receiving the service provider identifier and the verification information that are uploaded by the terminal, and comparing the uploaded verification information and service provider identifier with verification information and a service provider identifier that are pre-stored, where verification succeeds if the uploaded verification information and service provider identifier are the same as the pre-stored verification information and service provider identifier.

The uploaded verification information includes a character string input by the user on the verification interface. The pre-stored verification information includes a pre-stored character string.

In another implementation manner, the step of receiving the service provider identifier and verification information that is input on the verification interface that are uploaded by the terminal, and verifying the service provider identifier and the verification information, to obtain a verification result may also include: receiving the service provider identifier and the verification information that are uploaded by the terminal, and comparing the uploaded verification information and service provider identifier with verification information and a service provider identifier that are pre-stored, where verification succeeds if the uploaded verification information and service provider identifier are the same as the pre-stored verification information and service provider identifier.

The uploaded verification information includes a webpage address parameter obtained by scanning a two-dimensional code. The pre-stored verification information includes a pre-stored webpage address parameter.

To conclude, in the security check method of this embodiment, a verification server receives an interface switching instruction, and returns an original virtual resource accumulation page to a terminal according to the interface switching instruction, where the original virtual resource accumulation page corresponds to a user identifier and a service provider identifier selected by a user; then the verification server receives a virtual resource acquisition instruction input on the original virtual resource accumulation page, and returns a verification interface according to the virtual resource acquisition instruction; next, the verification server receives the service provider identifier and verification information that is input on the verification interface that are uploaded by the terminal, and verifies the service provider identifier and the verification information, to obtain a verification result; and finally, the verification server transmits the verification result to a virtual resource server, so that the virtual resource server returns a new virtual resource accumulation page to the terminal after verification succeeds, where the new virtual resource accumulation page includes an updated virtual resource accumulation quantity corresponding to the user identifier.

In the security check method of this embodiment, the verification server receives the service provider identifier and the verification information that is input on the verification interface that are uploaded by the terminal, verifies the service provider identifier and the verification information, and performs virtual resource accumulation after verification succeeds, which improves the efficiency and accuracy; and verification is completed by using the user terminal, which does not need to add a new hardware device to the service provider, and therefore reduces the cost.

Refer to FIG. 10, which is an interaction sequence diagram of a security check method according to an implementation manner. This embodiment is described by using an example in which the security check method is applied to the system shown in FIG. 1. The security check method includes:

S1010: The terminal 120 uploads a user identifier and a service provider identifier selected by a user to the virtual resource server 160 according to an interface switching instruction triggered by the user.

S1020: The virtual resource server 160 returns an original virtual resource accumulation page to the terminal 120 according to the interface switching instruction, and the user identifier and the service provider identifier that is selected by the user that are provided by the terminal 120.

S1030: The verification server 140 receives a virtual resource acquisition instruction that is input on the original virtual resource accumulation page by using the terminal 120, and returns a verification interface to the terminal 120.

S1040: The verification server 140 receives the service provider identifier and verification information that is input on the verification interface that are uploaded by using the terminal 120, and verifies the service provider identifier and the verification information, to obtain a verification result.

S1050: The virtual resource server 160 receives the verification result transmitted by the verification server 140, and returns a new virtual resource accumulation page to the terminal 120 after verification succeeds.

In the security check method of this embodiment, the verification server 140 receives the service provider identifier and the verification information that is input on the verification interface that are uploaded by the terminal 120, verifies the service provider identifier and the verification information, and performs virtual resource accumulation after verification succeeds, which improves the efficiency and accuracy.

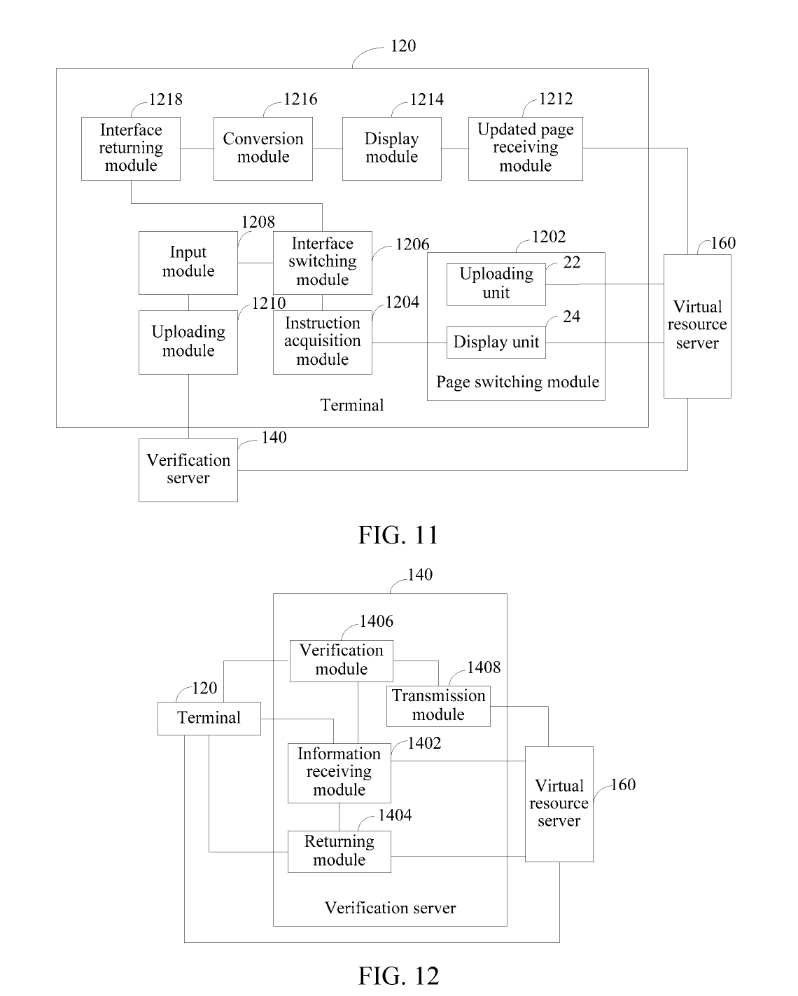

Refer to FIG. 11, which is a schematic structural diagram of the system 100 in FIG. 1. The terminal 120 includes a page switching module 1202, an instruction acquisition module 1204, an interface switching module 1206, an input module 1208, an uploading module 1210, and an updated page receiving module 1212.

The page switching module 1202 includes an uploading unit 22 and a display unit 24. The uploading unit 22 is configured to: trigger an interface switching instruction according to a selection operation, and upload, according to an interface switching instruction, a user identifier and a service provider identifier selected by a user to a virtual resource server. The display unit 24 is configured to receive and display an original virtual resource accumulation page that is returned by the virtual resource server 160 and includes the user identifier and the service provider identifier.

The instruction acquisition module 1204 is configured to receive a virtual resource acquisition instruction input by the user on the virtual resource accumulation page.

The interface switching module 1206 is configured to switch from the original virtual resource accumulation page to a verification interface according to the virtual resource acquisition instruction.

The input module 1208 is configured to receive verification information input on the verification interface. The uploading module 1210 is configured to upload the verification information and the service provider identifier to the verification server 140 for verification.

Specifically, in this implementation manner, the input module 1208 is configured to receive verification information input by a service provider on the verification interface; and then the uploading module 1210 is configured to upload the verification information and the service provider identifier to the verification server 140, so that the verification server 140 compares the received verification information and service provider identifier with verification information and a service provider identifier that are pre-stored, and verification succeeds if the received verification information and service provider identifier are the same as the pre-stored verification information and service provider identifier.

The uploaded verification information, that is, the verification information input by the service provider, includes a verification date and a sequence number input by the service provider and corresponding to the verification date. The pre-stored verification information includes a pre-stored sequence number and verification date.

In another implementation manner, the input module 1208 may be further configured to receive verification information input by the user on the verification interface; and then the uploading module 1210 is configured to upload the verification information and the service provider identifier to the verification server 140, so that the verification server 140 compares the uploaded verification information and service provider identifier with verification information and a service provider identifier that are pre-stored, and verification succeeds if the uploaded verification information and service provider identifier are the same as the pre-stored verification information and service provider identifier.

The uploaded verification information, that is, the verification information input by the user, includes a character string input by the user. The pre-stored verification information includes a pre-stored character string.

In another implementation manner, the input module 1208 may be further configured to receive a webpage address and webpage address parameter obtained by scanning a two-dimensional code on the verification interface, and receive a virtual resource acquisition trigger instruction on a page corresponding to the webpage address; and then the uploading module 1210 is configured to upload the verification information and the service provider identifier to the verification server according to the trigger instruction, so that the verification server compares the uploaded verification information and service provider identifier with verification information and a service provider identifier that are pre-stored, and verification succeeds if the uploaded verification information and service provider identifier are the same as the pre-stored verification information and service provider identifier.

The uploaded verification information includes the webpage address parameter obtained by scanning the two-dimensional code. The pre-stored verification information includes a pre-stored webpage address parameter.

The updated page receiving module 1212 is configured to receive a new virtual resource accumulation page that is returned by the virtual resource server 160 after verification of the verification server 140 succeeds. The new virtual resource accumulation page includes an updated virtual resource accumulation quantity corresponding to the user identifier.

It may be understood that, the new virtual resource accumulation page may further include a bonus resource that can be redeemed by the updated virtual resource accumulation quantity, a preset virtual resource accumulation quantity that needs to be reached by continued accumulation, and a bonus resource that can be redeemed by the preset virtual resource accumulation quantity. The terminal 120 of this embodiment may further include: a display module 1214, a redeem module 1216, and an interface returning module 1218.

The display module 1214 is configured to display the new virtual resource accumulation page. The new virtual resource accumulation page includes the bonus resource that can be redeemed by the updated virtual resource accumulation quantity, the preset virtual resource accumulation quantity that needs to be reached by continued accumulation, and the bonus resource that can be redeemed by the preset virtual resource accumulation quantity.

The redeem module 1216 is configured to acquire a redeem instruction, redeem the virtual resource for a bonus resource according to the redeem instruction, and deduct, from the updated virtual resource accumulation quantity, a virtual resource accumulation quantity required by redeeming the bonus resource.

The interface returning module 1218 is configured to acquire an accumulation continuing instruction, and return to the verification interface according to the accumulation continuing instruction.

It should be noted that, if security check is performed only to obtain a virtual resource and perform update and accumulation without bonus resource redemption by using a virtual resource, the display module 1214, the redeem module 1216, and the interface returning module 1218 can be omitted.

Refer to FIG. 12, which is a schematic structural diagram of the system 100 in FIG. 1. The verification server 140 includes an information receiving module 1402, a returning module 1404, a verification module 1406, and a transmission module 1408.

The information receiving module 1402 configured to receive an interface switching instruction. The returning module 1404 is configured to return an original virtual resource accumulation page to the terminal according to the interface switching instruction. The virtual resource accumulation page corresponds to a user identifier and a service provider identifier selected by a user.

The information receiving module 1402 is then configured to receive a virtual resource acquisition instruction input on the original virtual resource accumulation page. The returning module 1404 is configured to return a verification interface according to the virtual resource acquisition instruction.

The information receiving module 1402 is then configured to receive the service provider identifier and verification information that is input on the verification interface that are uploaded by the terminal. The verification module 1406 is configured to verify the received service provider identifier and verification information, to obtain a verification result.

Specifically, in this implementation manner, the information receiving module 1402 is configured to receive the service provider identifier and the verification information that are uploaded by the terminal, and the verification module 1406 is configured to compare the uploaded verification information and service provider identifier with verification information and a service provider identifier that are pre-stored, where verification succeeds if the uploaded verification information and service provider identifier are the same as the pre-stored verification information and service provider identifier.

The uploaded verification information includes a verification date and a sequence number that is input by a service provider on the verification interface. The pre-stored verification information includes a pre-stored sequence number and verification date.

In another implementation manner, the information receiving module 1402 may be further configured to receive the service provider identifier and the verification information that are uploaded by the terminal, and the verification module 1406 is further configured to compare the uploaded verification information and service provider identifier with verification information and a service provider identifier that are pre-stored, where verification succeeds if the uploaded verification information and service provider identifier are the same as the pre-stored verification information and service provider identifier.

The uploaded verification information includes a character string input by the user on the verification interface. The pre-stored verification information includes a pre-stored character string.

In another implementation manner, the information receiving module 1402 may be further configured to receive the service provider identifier and the verification information that are uploaded by the terminal, and the verification module 1406 is further configured to compare the uploaded verification information and service provider identifier with verification information and a service provider identifier that are pre-stored, where verification succeeds if the uploaded verification information and service provider identifier are the same as the pre-stored verification information and service provider identifier.

The uploaded verification information includes a webpage address parameter obtained by scanning a two-dimensional code. The pre-stored verification information includes a pre-stored webpage address parameter.

The transmission module 1408 is configured to transmit the verification result to the virtual resource server, so that the virtual resource server returns a new virtual resource accumulation page to the terminal after verification succeeds. The new virtual resource accumulation page includes an updated virtual resource accumulation quantity corresponding to the user identifier.

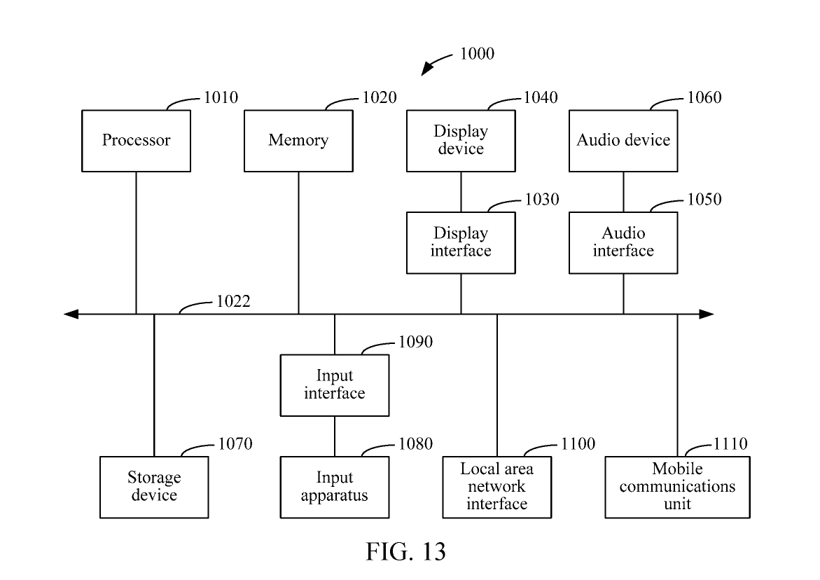

FIG. 13 is a diagram of modules of a computer system 1000 that can implement the embodiments of the present invention. The computer system 1000 is merely an example of computer system environments applicable to the present disclosure, and should not be construed as any limitation on the application scope of the present disclosure. The computer system 1000 also should not be interpreted as needing to rely on or have one or a combination of parts of the exemplary computer system 1000 shown in FIG. 13.

The computer system 1000 shown in FIG. 7 is an example of computer systems suitable for use in the present disclosure. Other architectures having different subsystem configurations may also be used. For example, a desktop computer, a notebook computer, a personal digital assistant, a smart phone, a tablet computer, a portable media player, a set-top box and other similar devices having a voice recording function are applicable to some embodiments of the present invention, but the present disclosure is not limited thereto.

As shown in FIG. 13, the computer system 1000 includes a processor 1010, a memory 1020, and a system bus 1022. Various system components including the memory 1020 and the processor 1010 are connected to the system bus 1022. The processor 1010 is hardware for executing computer program instructions by means of basic arithmetic and logic operations in the computer system. The memory 1020 is a physical device for temporarily or permanently storing computer programs or data (for example, program state information). The system bus 1022 may be any one of the following types of bus structures: a memory bus or memory controller, a peripheral bus and a local bus. The processor 1010 and the memory 1020 may perform data communication through the system bus 1022. The memory 1020 includes a read-only memory (ROM) or a flash memory (both not shown), and a random access memory (RAM), where the RAM generally refers to main memory loaded with an operating system and application programs.

The computer system 1000 further includes a display interface 1030 (for example, a graphics processing unit), a display device 1040 (for example, a liquid crystal display), an audio interface 1050 (for example, a sound card) and an audio device 1060 (for example, a loudspeaker). The display device 1040 and the audio device 1060 are media devices for presenting multimedia content.

The computer system 1000 generally includes one storage device 1070. The storage device 1070 may be selected from multiple types of computer readable media. The computer readable media refer to any available media that can be accessed by the computer system 1000, and include removable media and non-removable media. For example, the computer readable media include, but not limited to, a flash memory (micro SD card), a CD-ROM, a digital versatile disc (DVD) or other optical storage, a cassette, a magnetic tape, a disk storage or other magnetic storage devices, or any other media that can be used to store required information and can be accessed by the computer system 1000.

The computer system 1000 further includes an input device 1080 and an input interface 1090 (for example, an IO controller). A user may input an instruction and information into the computer system 1000 by using the input device 1080, such as a keyboard, a mouse or a touch panel device on the display device 1040. The input device 1080 is generally connected to the system bus 1022 through the input interface 1090, but may also be connected through other interfaces or bus structures, such as a universal serial bus (USB).

The computer system 1000 may be logically connected to one or more network devices in a network environment. The network device may be a personal computer, a server, a router, a smart phone, a tablet computer or other public network nodes. The computer system 1000 is connected to the network device through a local area network (LAN) interface 1100 or a mobile communications unit 1110. A local area network (LAN) refers to an interconnected computer network in a limited area such as a family, a school, a computer laboratory, or an office building using network media. WiFi and Ethernet over twisted pair are the most commonly used two technologies for building a local area network. WiFi is a technology that enables the computer systems 1000 to exchange data or to be connected to a wireless network through radio waves. The mobile communications unit 1110 is capable of making and receiving calls through radio communications lines while moving in a broad geographic area. In addition to calling, the mobile communications unit 1110 also supports Internet access in a 2G, 3G or 4G cellular communications system that provides mobile data services.

It should be noted that other computer systems including more or fewer subsystems than those of the computer system 1000 are also applicable to the present disclosure. For example, the computer system 1000 may include a Bluetooth unit capable of exchanging data in a short distance, an image sensor for capturing images, and an accelerometer for measuring the acceleration.

As described above in detail, the computer system 1000 applicable to the present disclosure can execute specified operations in the security check method. The computer system 1000 executes these operations in the form of running software instructions in the computer readable media by the processor 1010. These software instructions may be read into the memory 1020 from the storage device 1070 or from another device through the local area network interface 1100. The software instructions stored in the memory 1020 enable the processor 1010 to execute the security check method. Moreover, the present disclosure may also be implemented by using a hardware circuit or by using a combination of a hardware circuit and software instructions. Therefore, the implementation of the present disclosure is not limited to any particular combination of a hardware circuit and software.

The described embodiments are merely some embodiments of the present invention, which are specifically and detailedly described. However, it should not be understood as a limitation to the patent scope of the present disclosure. It should be noted that, persons of ordinary skill in the art may further make some variations and improvements without departing from the concept of the present disclosure, and the variations and improvements belong to the protection scope of the present disclosure. Therefore, the protection scope of the present disclosure shall be subject to the protection scope of the appended claims.

What is claimed is:

1. A security check method, comprising:
logging into an electronic operation platform by using a user identifier, an operation interface provided by the electronic operation platform having multiple service provider identifiers;
receiving a user selection operation on one of the service provider identifiers on the operation interface;
switching, according to the selection operation, from the operation interface to an original virtual resource accumulation page corresponding to the user identifier and the user-selected service provider identifier;
receiving a virtual resource acquisition instruction input by the user on the original virtual resource accumulation page;
switching from the original virtual resource accumulation page to a verification interface according to the virtual resource acquisition instruction;
receiving verification information input on the verification interface, and uploading the verification information and the service provider identifier to a verification server for verification; and
receiving a new virtual resource accumulation page that is returned by a virtual resource server after verification of the verification server succeeds, wherein the new virtual resource accumulation page comprises an updated virtual resource accumulation quantity corresponding to the user identifier.

2. The method according to claim 1, wherein the step of switching, according to the selection operation, from the operation interface to an original virtual resource accumulation page corresponding to the user identifier and the user-selected service provider identifier comprises:
triggering an interface switching instruction according to the selection operation, and uploading, according to the interface switching instruction, the user identifier and the user-selected service provider identifier to the virtual resource server; and
receiving and displaying the original virtual resource accumulation page that is returned by the virtual resource server, the original virtual resource accumulation page including a virtual resource accumulation quantity corresponding to the user identifier and the user-selected service provider identifier.

3. The method according to claim 1, wherein the step of receiving verification information input on the verification interface, and uploading the verification information and the service provider identifier to a verification server for verification comprises:
receiving verification information input by a service provider on the verification interface, and uploading the verification information and the user-selected service provider identifier to the verification server, wherein the verification server is configured to compare the uploaded verification information and the user-selected service provider identifier with pre-stored verification information and a service provider identifier, and verification succeeds if the uploaded verification information and the user-selected service provider identifier are the same as the pre-stored verification information and service provider identifier, wherein the uploaded verification information comprises a verification date and a sequence number input by the service provider and corresponding to the verification date, and the pre-stored verification information comprises a pre-stored sequence number and verification date.

4. The method according to claim 1, wherein the step of receiving verification information input on the verification interface, and uploading the verification information and the service provider identifier to a verification server for verification comprises:
receiving verification information input by the user on the verification interface, and uploading the verification information and the user-selected service provider identifier to the verification server, wherein the verification server is configured to compare the uploaded verification information and the user-selected service provider identifier with pre-stored verification information and a service provider identifier, and verification succeeds if the uploaded verification information and the user-selected service provider identifier are the same as the pre-stored verification information and service provider identifier, wherein the uploaded verification information comprises a character string input by the user, and the pre-stored verification information comprises a pre-stored character string.

5. The method according to claim 1, wherein the step of receiving verification information input on the verification interface, and uploading the verification information and the service provider identifier to a verification server for verification comprises:
receiving a webpage address and webpage address parameter obtained by scanning a two-dimensional code on the verification interface, receiving a virtual resource acquisition trigger instruction on a page corresponding to the webpage address, and uploading the verification information and the user-selected service provider identifier to the verification server according to the user selection operation, wherein the verification server is configured to compare the uploaded verification information and the user-selected service provider identifier with pre-stored verification information and a service provider identifier, and verification succeeds if the uploaded verification information and service provider identifier are the same as the pre-stored verification information and service provider identifier, wherein the uploaded verification information comprises the webpage address parameter obtained by scanning the two-dimensional code, and the pre-stored verification information comprises a pre-stored webpage address parameter.

6. The method according to claim 1, wherein the new virtual resource accumulation page further comprises a bonus resource that can be redeemed by the updated virtual resource accumulation quantity, a preset virtual resource accumulation quantity that needs to be reached by continued accumulation, and a bonus resource that can be redeemed by the preset virtual resource accumulation quantity; and
after the step of receiving a new virtual resource accumulation page that is returned by a virtual resource server after verification of the verification server succeeds, the method further comprises:
displaying the bonus resource that can be redeemed by the updated virtual resource accumulation quantity, the preset virtual resource accumulation quantity that needs to be reached by continued accumulation, and the bonus resource that can be redeemed by the preset virtual resource accumulation quantity.

7. The method according to claim 6, further comprising:
acquiring a redeem instruction, redeeming the virtual resource for a bonus resource according to the redeem instruction, and deducting, from the updated virtual resource accumulation quantity, a virtual resource accumulation quantity required by redeeming the bonus resource; and
acquiring an accumulation continuing instruction, and returning to the verification interface according to the accumulation continuing instruction.

8. A security check method, comprising:
receiving an interface switching instruction from a user of a terminal, and returning, to the terminal, an original virtual resource accumulation page corresponding to a user identifier associated with the terminal and a service provider identifier selected by a user of the terminal;
receiving a virtual resource acquisition instruction input on the original virtual resource accumulation page, and returning a verification interface according to the virtual resource acquisition instruction;
receiving the user-selected service provider identifier and verification information that is input on the verification interface that are uploaded by the terminal, and verifying the user-selected service provider identifier and the verification information, to obtain a verification result; and
transmitting the verification result to a virtual resource server, wherein the virtual resource server is configured to return a new virtual resource accumulation page to the terminal after verification succeeds, wherein the new virtual resource accumulation page comprises an updated virtual resource accumulation quantity corresponding to the user identifier.

9. The method according to claim 8, wherein the step of receiving the user-selected service provider identifier and verification information that is input on the verification interface that are uploaded by the terminal, and verifying the user-selected service provider identifier and the verification information, to obtain a verification result comprises:
receiving the user-selected service provider identifier and the verification information that are uploaded by the terminal, wherein the uploaded verification information comprises a verification date and a sequence number input by a service provider on the verification interface and corresponding to the verification date; and
comparing the uploaded verification information and the user-selected service provider identifier with pre-stored verification information and a service provider identifier, wherein verification succeeds if the uploaded verification information and the user-selected service provider identifier are the same as the pre-stored verification information and service provider identifier, wherein the pre-stored verification information comprises a pre-stored sequence number and verification date.

10. The method according to claim 8, wherein the step of receiving the user-selected service provider identifier and verification information that is input on the verification interface that are uploaded by the terminal, and verifying the user-selected service provider identifier and the verification information, to obtain a verification result comprises:
receiving the user-selected service provider identifier and the verification information that are uploaded by the terminal, wherein the uploaded verification information comprises a character string input by the user on the verification interface; and
comparing the uploaded verification information and the user-selected service provider identifier with pre-stored verification information and a service provider identifier, wherein verification succeeds if the uploaded verification information and the user-selected service provider identifier are the same as the pre-stored verification information and service provider identifier, wherein the pre-stored verification information comprises a pre-stored character string.

11. The method according to claim 8, wherein the step of receiving the user-selected service provider identifier and verification information that is input on the verification interface that are uploaded by the terminal, and verifying the user-selected service provider identifier and the verification information, to obtain a verification result comprises:
receiving the user-selected service provider identifier and the verification information that are uploaded by the terminal, wherein the uploaded verification information comprises a webpage address parameter obtained by scanning a two-dimensional code; and
comparing the uploaded verification information and the user-selected service provider identifier with pre-stored verification information and a service provider identifier, wherein verification succeeds if the uploaded verification information and the user-selected service provider identifier are the same as the pre-stored verification information and service provider identifier, wherein the pre-stored verification information comprises a pre-stored webpage address parameter.

12. A terminal, comprising:
a page switching module, configured to: log into an electronic operation platform by using a user identifier, an operation interface provided by the electronic operation platform having multiple service provider identifiers; receiving a user selection operation on one of the service provider identifiers on the operation interface; switching, according to the selection operation, from the operation interface to an original virtual resource accumulation page corresponding to the user identifier and the user-selected service provider identifier;
an instruction acquisition module, configured to receive a virtual resource acquisition instruction input by the user on the original virtual resource accumulation page;
an interface switching module, configured to switch from the original virtual resource accumulation page to a verification interface according to the virtual resource acquisition instruction;
an input module, configured to receive verification information input on the verification interface;
an uploading module, configured to upload the verification information and the service provider identifier to a verification server for verification; and
an updated page receiving module, configured to receive a new virtual resource accumulation page that is returned by a virtual resource server after verification of the verification server succeeds, wherein the new virtual resource accumulation page comprises an updated virtual resource accumulation quantity corresponding to the user identifier.

13. The terminal according to claim 12, wherein the page switching module comprises:
an uploading unit, configured to: trigger an interface switching instruction according to the selection operation, and uploading, according to the interface switching instruction, the user identifier and the user-selected service provider identifier to the virtual resource server; and
a display unit, configured to receive and display the original virtual resource accumulation page that is returned by the virtual resource server, the original virtual resource accumulation page including a virtual resource accumulation quantity corresponding to the user identifier and the user-selected service provider identifier.

14. The terminal according to claim 12, wherein the input module is further configured to receive verification information input by a service provider on the verification interface; and
the uploading module is further configured to upload the verification information and the user-selected service provider identifier to the verification server, wherein the verification server is configured to compare the received verification information and the user-selected service provider identifier with pre-stored verification information and a service provider identifier, and verification succeeds if the received verification information and the user-selected service provider identifier are the same as the pre-stored verification information and service provider identifier, wherein the uploaded verification information comprises a verification date and a sequence number input by the service provider and corresponding to the verification date, and the pre-stored verification information comprises a pre-stored sequence number and verification date.

15. The terminal according to claim 12, wherein the input module is further configured to receive verification information input by the user on the verification interface; and
the uploading module is further configured to upload the verification information and the user-selected service provider identifier to the verification server, wherein the verification server is configured to compare the uploaded verification information and the user-selected service provider identifier with pre-stored verification information and a service provider identifier, and verification succeeds if the uploaded verification information and the user-selected service provider identifier are the same as the pre-stored verification information and service provider identifier, wherein the uploaded verification information comprises a character string input by the user, and the pre-stored verification information comprises a pre-stored character string.

16. The terminal according to claim 12, wherein the input module is further configured to receive a webpage address and webpage address parameter obtained by scanning a two-dimensional code on the verification interface, and receive a virtual resource acquisition trigger instruction on a page corresponding to the webpage address; and
the uploading module is further configured to upload the verification information and the user-selected service provider identifier to the verification server according to the user selection operation, wherein the verification server is configured to compare the uploaded verification information and the user-selected service provider identifier with pre-stored verification information and a service provider identifier, and verification succeeds if the uploaded verification information and the user-selected service provider identifier are the same as the pre-stored verification information and service provider identifier, wherein the uploaded verification information comprises the webpage address parameter obtained by scanning the two-dimensional code, and the pre-stored verification information comprises a pre-stored webpage address parameter.

17. The terminal according to claim 12, wherein the new virtual resource accumulation page further comprises a bonus resource that can be redeemed by the updated virtual resource accumulation quantity, a preset virtual resource accumulation quantity that needs to be reached by continued accumulation, and a bonus resource that can be redeemed by the preset virtual resource accumulation quantity; and
the terminal further comprises:
a display module, configured to display the bonus resource that can be redeemed by the updated virtual resource accumulation quantity, the preset virtual resource accumulation quantity that needs to be reached by continued accumulation, and the bonus resource that can be redeemed by the preset virtual resource accumulation quantity.

18. The terminal according to claim 17, further comprising:
a redeem module, configured to acquire a redeem instruction, redeem the virtual resource for a bonus resource according to the redeem instruction, and deduct, from the updated virtual resource accumulation quantity, a virtual resource accumulation quantity required by redeeming the bonus resource; and
an interface returning module, configured to acquire an accumulation continuing instruction, and return to the verification interface according to the accumulation continuing instruction.
